(19) United States
(12) Patent Application Publication
(10) Pub. No.: US 2014/0186545 A1
(43) Pub. Date: Jul. 3, 2014

(54) METHOD FOR PRODUCING HIGH TRANSMISSION GLASS COATINGS

(71) Applicant: LINDE AKTIENGESELLSCHAFT, Munchen (DE)

(72) Inventors: Stephen Carney, Munich (DE); Eric Hultstein, Munich (DE)

(21) Appl. No.: 14/236,123

(22) PCT Filed: Jul. 31, 2012
(86) PCT No.: PCT/EP2012/003258

§ 371 Date: Mar. 5, 2014

(30) Foreign Application Priority Data
Aug. 2, 2011 (EP) 11006350.0

(51) Int. Cl. C03C 17/25

(52) U.S. Cl. CPC C03C 17/25
USPC 427/535; 427/162; 427/557

(57) ABSTRACT

The invention is a method for producing a porous coating on a glass surface, wherein an aqueous potassium silicate solution is applied to the glass surface and a porous silicate coating is formed on said glass surface. The pH of the potassium silicate solution is controlled and the formation of the silicate coating is carried out in a process atmosphere of which the relative humidity is controlled.

The invention relates to a method for producing a high transmission coating on a glass surface, wherein an aqueous potassium silicate solution is applied to the glass surface.

It is known to apply transparent coatings to a glass substrate in order to improve its optical properties. A particular kind of optical coatings, which increase the light transmission through the glass substrate by reduction of its surface reflectivity, are interference antireflection coatings. An efficient interference antireflection coating on glass requires coating material, which is transparent and has a lower refractive index than the glass substrate. The optimal refractive index of the coating n(coat) should equal square root of the refractive index of the glass substrate n(glass). This requires n(coat) to be as low as 1.3 to 1.4 for the typical flat glass with n(glass) ˜1.52-1.56. The reflectivity is suppressed around light wavelength λ(min)=4×n(coat)×d(coat), where d(coat) is the thickness of the coating. In result, the transmission of light through the glass is increased around this wavelength. Transparent, low refractive index materials, such as LiF (n˜1.39), MgF₂ (n˜1.38), CaF₂ (n˜1.43), are commonly used as antireflection coatings. Drawbacks of this kind of coatings are the weak adhesion of the coating material to the glass substrate and the sophisticated PVD methods of their fabrication.

From U.S. Pat. No. 3,326,715 it is also known to produce silicate antireflection coatings on glass substrates by applying aqueous potassium silicate solutions on the glass surface followed by drying or thermal setting of the liquid film in ambient air atmosphere. The coatings, produced in that way, have a significantly reduced reflection but their refractive index is close to glass, which is too high for an optimal interference antireflection coating and therefore the increase in transmission is insubstantial. Furthermore, the so-prepared coatings develop a hazy appearance, referred to as “bloom”, shortly after their fabrication due to the formation of alkali carbonates by interaction of the excess alkali in the coating with the CO₂ from the air. The “bloom”, which is difficult to remove after its formation, decreases additionally the transmission of the glass/coating system.

U.S. Pat. No. 4,578,100 discloses a method for preventing the appearance of “bloom” by treating the coating with an acid after the solid coating has been made but before the “bloom” appears. Thus, the negative effect of the bloom on the glass transmission is avoided. Nevertheless, the refractive index of such a coating, prepared by fast drying, is close to that of the glass substrate and thus, is too high for an optimal interference coating.

U.S. Pat. No. 3,301,701 discloses a method for manufacturing of nano-structured nonreflective silica coatings on glass by using aqueous solution of sodium silicate as precursor. An aqueous silicate solution is mixed with a coacervating agent, which is then applied to an activated glass surface. However, the process of glass surface activation and precipitation of the coating is time consuming.

It is an objective of the invention to provide a method for producing glass with a high optical transmission. It is further an object of the invention to provide a method for deposition of a transparent nano-porous silica film, which is an effective optical medium of significantly lower refractive index than that of the glass substrate.

This object is solved by a method for producing a high transmission coating on a glass surface, wherein an aqueous potassium silicate solution is applied to the glass surface, and which is characterized in that after the potassium silicate solution has been applied to the glass surface and while the potassium silicate is in liquid phase, the potassium silicate solution is exposed to a process atmosphere wherein the relative humidity of the process atmosphere is controlled.

The invention provides a silica coating with a refractive index lower than those achieved by the methods known in the prior art. The method uses aqueous potassium silicate solution as a precursor of the coating. The inventive process is based on the ordinary cross-linking reactions between the silicate ions in the solution, but employs process conditions which enable control of the porosity of the final coating and thus, the structural control of its refractive index.

Potassium silicate is a chemical compound of the general formula Kₓ(SiO₃)_{y}, which dissolves in water by dissociation to K⁺ cations and corner shared silicate anions (SiO₄⁻). The exchange of K⁺ ion with H⁺ ion in water environment results in formation of silicic acids [Si(OH)₄, H₂SiO₃ etc.] in the solution. In general, an aqueous potassium silicate solution is a mixture of dissolved potassium silicate and silicic acids in a ratio depending on the pH of the solution. A shorthand way for characterization of such mixture uses the ratio of the silicon and potassium oxide species present in the solution X═SiO₂:K₂O. Aqueous solutions of this kind are often also referred to as potassium water glass.

In general, a potassium silicate solution (potassium water glass) with a molar ratio of SiO₂:K₂O lower than 6 and concentration of the silicate in the water up to 10% is stable at a pH factor of typically about 10 to 12. Such solutions are commercially available, can be kept in storage for long time, and can be used as liquid precursors for formation of the desired optical coatings.

By evaporation of the water from a potassium silicate solution the overall concentration of the active silicate substance can be increased. Thereby, the potassium silicate solution is destabilised by initiation of crosslinking of the silicic acids—initially resulting in oligomerization to higher silicic acids and further in a formation of linear or cyclic (SiO₂)ₙ polymers and finally in condensation of solid 3-dimensional SiO₂ structures.

The term “cross-linking” shall mean that silicate units (ions) oligomerise and polymerise to a 1-, 2- or 3-dimensional network by formation of siloxane bonds (—Si—O—Si—). In particular, cross-linking shall mean that the silicic acid molecules in the solution interact via dehydration of their OH terminations to form a siloxane bond according to the reaction:

->Si—O—H+H—O—Si<->->Si—O—Si<-+H₂O,

wherein the sign -> denotes bondings to three O neighbors—either OH groups or O from already formed siloxane bonds.

The cross-linking reactions in an aqueous potassium silicate solution can be stimulated by increasing the concentration of the silicic acid component in two general ways:
i) By evaporation of the water from the solution the overall concentration of the active silicate substance (both silicic acids and potassium silicate) increases. Thereby, the interaction of the silicic acid molecules via cross-linking is increased—initially resulting in oligomerization to higher silicic acids and further in a formation of linear or cyclic (SiO₂)ₙ polymers and finally in condensation of solid 3-dimensional SiO₂ network.
ii) By adding acid to the solution the concentration of H⁺ ions is increased—i.e. the pH of the solution is reduced. This results in an additional exchange of K⁺ ions with H⁺ ions and hence, in an increase of the silicic acids concentration and a corresponding reduction of potassium silicate component. The excess K⁺ cations tend to bind with the anions of the acid resulting in a soluble salt (e.g. if HCl is added, the H⁺ substitutes K⁺ from the K₂SiH₃, the later binding with Cl⁻ to form KCl). Thus, the particular increase of the silicic acid component increases the probability of cross-linking reactions.

The prior art methods for formation of silicate antireflection coatings by drying the solution in uncontrolled ambient or higher temperature atmospheres use the first way i) as described above. In this case, the crosslinking reactions are localised close to the glass surface due to the evaporation of the water causing shrinking of the liquid layer of silicate solution and an increase in the concentration of silicic acids at the glass surface. Therefore, the crosslinking results predominantly in growth of compact SiO₂ coating with too high refractive index over the glass.

In contrast to the prior art, it is characteristic for the invention that after the application of the aqueous potassium silicate solution, the liquid layer on the glass surface is treated before drying for a certain duration in a process atmosphere of controlled relative humidity.

The water vapour is used to inhibit the evaporation of H₂O from the liquid solution. Preferably, the partial pressure of the water vapour in the gas mixture PPG_{H2O} is kept equal to the standard vapour pressure of H₂O at the temperature of the glass surface SVP_{H2O}. At this condition, the H₂O evaporation rate equals the H₂O condensation rate—i.e this is a “regime of zero net evaporation”. Thus, the potassium silicate layer can be kept in liquid state as long as desired and particularly for the whole duration of the process atmosphere treatment. The process atmosphere treatment can also be carried out in a regime of slow evaporation (PPG_{H2O}<SVP_{H2O}) or in regime of increasing water content on the solution (PPG_{H2O}>SVP_{H2O}).

The final size of the solid SiO₂ particles is determined by the duration of the process atmosphere treatment, which is controlled by the residence time of the glass. It has been found that colloidal solutions of submicrometer size particles can be formed during several minutes of treatment in the process atmosphere.

According to the invention, first an aqueous potassium silicate solution is applied to the glass surface by any common means of applying liquid solutions onto substrates or surfaces—for instance by spraying, painting, rolling, dip coating etc. A preferable method is spray coating, which uses a pump and a nozzle designed to diffuse the potassium silicate solution into fine droplets. In an embodiment of the invention, the spraying is driven by use of inert carrier gas which acts as a propellant.

It is known that in order to achieve a high transmission surface coating the porosity of the coating produced using potassium silicate solutions has to be increased compared to the prior art coatings. Therefore, the nucleation process in the liquid phase has to be controlled in such a way that the number of separate sites at which nucleation starts in the liquid phase is increased and that the glass surface is not permitted to be the dominant location for origination and/or starting of the polymerization process. That rate control influences the final coating porosity and the optical properties of the coating. In this way control of the nucleation in the liquid phase allows structural control of the refractive index.

According to the invention the desired porosity is achieved by developing the silicate coating in a process atmosphere of which the relative humidity is controlled. The term “control” shall mean that the relative humidity of the atmosphere is purposefully set, changed, regulated or actively influenced in order to optimise the development of a porous surface coating. The term “control” shall in particular mean that the relative humidity of the atmosphere is purposefully set, changed, regulated or actively influenced to meet predetermined requirements, especially to get a relative humidity within a predetermined range or above a predetermined minimum level.

Preferably the duration of the liquid phase is controlled. The applied potassium silicate solution is not simply dried in ambient atmosphere but maintained as long as required in the liquid phase. By controlling the water vapour concentration in the process atmosphere the evaporation rate and thus the duration of the liquid phase can be controlled.

Water evaporation depends on the relative humidity of the atmosphere. The term “relative humidity” shall mean the ratio of the partial pressure of water vapor in the atmosphere to the saturated vapor pressure under those conditions. The higher the concentration of water in the process atmosphere, i.e. the higher the relative humidity of the process atmosphere, the slower the water in the aqueous potassium silicate solution will evaporate.

According to a preferred embodiment air of controlled humidity is used as process atmosphere. That means, the humidity of the air is set to a predefined or predetermined value or range. Preferably the air is passed through a water bath in order to load the air with water vapour. It is also possible to use other methods for loading the air with water vapour, for example by blowing water vapour into the air. Passing the air through a water bath is a preferred embodiment since depending on the contact time of air and water it is possible to get air saturated with water vapour, i.e. air with a well defined humidity of 100%. By adding dry air to the saturated air, air with a certain predefined relative humidity can be produced.

Preferably the relative humidity of the process atmosphere is set and/or controlled to be higher than 60%, 70%, 75%, 80% or 90% or 95%.

Normal air contains a certain amount/concentration of carbon dioxide which in aqueous conditions forms a weak acid. The carbon dioxide will react with the potassium silicate solution causing the pH to change as carbonic acid is formed. The carbonic acid will lower the pH of the liquid potassium silicate solution present on the glass surface and initiate the cross-linking process of the silicate molecules as described above.

According to the invention the potassium silicate solution applied to the glass surface is kept in a humid process atmosphere such that the evaporation of the liquid potassium silicate solution is reduced or even stopped and the contact time between the acid-forming components of the air, in particular carbon dioxide, and the liquid potassium silicate solution is enhanced. The pH of the potassium silicate solution is reduced during the time when the potassium silicate is in liquid phase. By decreasing the pH of the potassium silicate solution nucleation sites are generated and cross-linking is initiated within the liquid phase.

At low enough pH, this process continues first with formation of oligomers and then polymers. In the late stage, further polymerization takes place resulting in formation of 3-dimensional colloidal particles of SiO₂ within the liquid phase. These colloidal particles have a size in the order of 5 nm to 30 nm diameter and agglomerate to form the inventive coating with an inter-colloidal porosity on a nanometer scale. It is this inter-colloidal porosity which contributes most to the low refractive index of the inventive coating.

A so formed porous silicate film is an effective optical medium of low refractive index which increases the transmission of a glass significantly.

The invention can be used to produce a porous coating on any kind of glass, for example tube glass, glass bulbs, mirror glass or glass used in the automotive industry. A preferred field of application is the production of coated flat glass, in particular of float glass.

Prior to applying the potassium silicate solution to the glass, the surface of the glass can be prepared, for example to manage the variability of the surface wetting behaviour of different glasses and to prepare the glass surface for high wetting capability. This can be achieved by one or more treatments such as washing with clean de-ionized water or mild acid solutions, flame treatment and plasma activation.

The potassium silicate solution can be applied to the glass surface by spraying or rolling or by any other method which is known to apply aqueous solutions. The spraying mechanism preferably comprises a pump and a nozzle which is designed to diffuse the potassium silicate solution into fine droplets. In another preferred embodiment the spraying is achieved by means of a carrier gas which acts as a propellant.

The potassium silicate solution applied to the glass surface is then exposed to a process atmosphere and the relative humidity and/or the water vapour partial pressure of the process atmosphere are preferably controlled. As mentioned above, the humid atmosphere is preferably produced by passing air through a water bath in order to load the air with water vapour. The relative humidity of the controlled atmosphere depends on the temperatures of the water bath, the air and the glass and can thus be controlled by varying one or more of these temperatures. Further, the humid gas can be mixed with a dry gas to produce a gas of a certain relative humidity. It is also possible to use another gas rather than air and to load that gas with water vapour to produce the humid process atmosphere.

The formation of the porous silicate structure, i.e. the development from liquid phase nucleation of silicate units, is initiated by lowering the pH of the potassium silicate solution. Preferably, air of controlled humidity is used as process atmosphere. The carbon dioxide present in the air is the preferred acid forming gas which reacts with the water of the aqueous potassium silicate solution. The CO₂ will react with the water in the potassium silicate solution to form HCO₃⁻ and protons H⁺ and thereby lower the pH of the potassium silicate solution.

In another embodiment this is achieved by adding to the process atmosphere a substance which can act as a proton donor. That substance is preferably an acid forming gas, such as HCl. It is also possible to add to the process atmosphere another gaseous or liquid substance or a material in the plasma state which provide protons. Any substance which directly or indirectly makes hydrogen ions available can be used as proton donor.

The proton donating substance should be provided to the still wet potassium silicate layer on the glass surface. The substance will make available a hydrogen ion which breaks up a Si—O bond and which effects the development of oligomeric silicate units. Thus, at several sites in the aqueous silicate solution the formation of a silica gel starts giving a wide-spread porous structure.

As an example, an acid forming gas such as HCl may be used as proton donor. An inert gas, preferably nitrogen, is blended with the acid forming gas to get a gas mixture with the inert gas as main component. The concentration of the acid forming gas in the gas mixture is for example between 1% by volume and 10% by volume or below 5% by volume. That gas mixture is then added to the process atmosphere.

When the pH of the potassium silicate solution is lowered the cross-linking of the silicate units starts and the silicate units in the potassium silicate solution will begin to oligomerize and polymerize.

In one embodiment of the invention the relative humidity of the process atmosphere is chosen such that the thickness of the aqueous layer on the glass substrate remains the same until a porous silicate coating of a pre-defined height has been formed. This is preferably done by first performing tests under constant process conditions in order to identify the process parameters, such as for example relative humidity and temperature of the process atmosphere, temperature of the glass, composition and pH of the potassium silicate solution, which are necessary to achieve a porous silicate coating of a particular height. The test results are then used in industrial scale application to set the process conditions to get the desired porous silicate coating properties.

In another embodiment the thickness of the aqueous layer is allowed to decrease in a controlled way during the formation of the porous silica gel.

According to another embodiment the partial pressure of the water vapour in the process atmosphere or the relative humidity of the process atmosphere is controlled to keep the potassium silicate solution in the liquid state for at least 2 minutes, for at least 5 minutes or for at least 7 minutes. During that time evaporation of water from the potassium silicate solution is reduced compared to the evaporation rate in ambient atmosphere, minimized or even prevented by controlling the relative humidity of the process atmosphere (or the partial water vapour pressure). For example, the process atmosphere contains air saturated with water vapour. The glass surface with the applied liquid potassium silicate solution is subjected to that process atmosphere for 5 to 7 minutes in order to minimize or stop evaporation of water and to maintain a liquid solution until the silicate units have cross-linked to the desired porous structure.

Another embodiment of the invention relates to the combined and simultaneous evaporation of water and stimulation of the cross-linking. By decreasing the pH—either by explicitly adding an acid forming gas to the process atmosphere or by implicitly using the CO₂ present in air as acid forming gas—the cross-linking process is initiated. By controlling the humidity of the process atmosphere the evaporation of the water is controlled so that cross-linking and drying occur simultaneously. By controlling the water vapour concentration in the process atmosphere the evaporation process can be controlled to make sure that the silicate units still cross-link in an aqueous layer.

The cross-linking of the silicate units and the evaporation of the water from the potassium silicate solution can be achieved step-by-step or simultaneously.

For formation of a silicate surface coating with optimum porous structure the pH value of the potassium silicate solution on the glass surface should be controlled to be between 5 and 9. A maximal agglomeration of the silicate units to a porous silica gel is expected to be in the region of neutral pH. At lower pH values the potassium silicate solution will be stable and no cross-linking will occur. Depending on the silicate concentration in the potassium silicate solution there is a pH range around neutral pH 7 where cross-linking of the silicate units occurs. At low pH values and at high pH values the potassium silicate solution is stable. The invention controls the silicate cross-linking and the formation of silica gel by shifting and controlling the pH of the potassium silicate solution.

In another embodiment controlled concentrations of acid vapours are introduced into the process atmosphere. The preferred acid is HCl.

As described above the nucleation and formation of porous silicate coating depends on the water evaporation rate and on the pH of the potassium silicate solution. Both parameters, evaporation rate and pH, are preferably controlled to get an optimum result.

Furthermore, the molar ratio of SiO₂:K₂O has an influence on the final formation of cross-linked silica gel. It has been found that that ratio should preferably be between 3:1 and 6:1. The concentration of the potassium silicate in the potassium silicate solution should preferably be between 0.5% by volume and 10% by volume, between 0.5% by volume and 3 % by volume or between 0.5% by volume and 1.5% by volume.

In order to reduce the reflection and increase the transmission even more it is preferred to deposit a coating with two or more porous silicate layers on the glass surface. Alternating layers of different refractive index material make it possible to further increase the transmission. By the same method it is also possible to produce a coating which has a very low reflectivity over a broad band of wavelengths. At least one of the porous silicate layers is produced according to the inventive method.

Such a multi-layer coating could for example be produced by the following method steps:
Application of potassium silicate solution to the glass surface
Drying of the potassium silicate solution at ambient conditions
Second application of potassium silicate solution
Formation of a porous silicate layer in a process atmosphere with controlled humidity and controlled pH conditions according to the invention.

The invention allows to fine-tune the development of the porous silicate coating and to control the optical properties of the resulting silicate coating. Thickness and refractive index of the produced silicate coating can be controlled. Thereby, it is also possible to produce multi-layer anti reflection coatings with two, three or more layers which have a high transmission over a broad wavelength band.

The invention is in particular useful for the production of solar photovoltaic systems, solar thermal glass or glass mirrors, solar thermal glass tubes, LED glass systems, or for light transmission control of multi-pane architectural glass. The inventive high transmission coating can be produced on flat glass and also on any other kind of glass.

A preferred field of application of glass, especially flat glass, produced according to the present invention is its use as substrate, cover plate and/or base plate for solar modules. Solar modules using such a substrate or cover plate or base plate can achieve a higher efficiency due to the improved anti reflection and transmission properties.

The invention allows to produce glass with substantially increased transmission compared to uncoated glass or to glass coated by prior art methods. The inventive formation of a porous silicate coating in a controlled atmosphere allows to set the transmission peak of the glass in the range required for specific solar cell peak performance. A major advantage in comparison to known glass coatings is that the porous silicate coating is part of the monolithic body of the glass.

### EXAMPLES

### Example 1

### Single Layer Application

This example relates to the production of a high transmission coating consisting of a single porous silicate layer. In a first step a glass pane is prepared to improve the wetting behaviour of its surface. The surface preparation may include treating of the glass pane with de-ionised water, a mild acid solution or other surface treatments such as flame or plasma treatment.

Then a potassium silicate solution is applied, preferably sprayed, onto the glass surface which has a temperature between 15° C. and 80° C. Important factors are the quantity and distribution of the potassium silicate solution on the glass. It has been shown that by spraying the potassium silicate solution with an inert gas as propellant an even distribution over the glass surface can be achieved. The quantity of potassium silicate solution applied depends on the desired coating thickness and on the concentration of SiO₂ in the potassium silicate solution. To produce a coating with a thickness of 150 nm with a potassium silicate solution comprising a 2% concentration of potassium silicate a 5 to 10 micrometer thick layer of potassium silicate solution is deposited on the glass surface. As a first approximation there is a linear proportionality between the desired coating thickness and the thickness of the potassium solution layer and a reciprocal proportionality between the potassium silicate concentration and the thickness of the potassium solution layer. For example: Keeping the potassium silicate concentration constant the thickness of the potassium silicate solution layer has to be doubled to get a porous silicate coating of double thickness. Or using a 4% concentrated potassium silicate solution requires only a 2.5 to 5 micrometer potassium silicate solution layer on the glass surface to get a 150 nm coating.

In the next step the potassium silicate solution on the glass pane is cured, i.e. nucleation that permits cross-linking is initiated in a controlled manner in a controlled process atmosphere. The rate of water evaporation from the potassium silicate solution is controlled by the relative humidity of the inventive process atmosphere. The process atmosphere comprises as main component air which has been loaded with water vapour. The air is preferably bubbled through water to get moist air. Preferably, the water has a temperature between 20° C. and 80° C.

When a sufficient degree of cross-linking and agglomeration of the silicate units and silicate chains has been reached the potassium silicate solution is dried to remove the water from the glass surface. The drying and evaporation is carried out in a nitrogen atmosphere or in dry air. It can be assisted by infrared radiation or other heating means.

Next, it is preferred to wash out any potassium ions and potassium carbonates. That washing step can use water from ambient temperature up to boiling point or dilute acid solutions.

Finally, the coated glass pane can be dehydrated by means of exposure to thermal toughening, infrared (IR) lamps, burners, halogen lamps or radio waves to drive off any water of hydration.

Glass produced by that method shows a reflectivity of about 1% per side, i.e. a total reflection at the minimum of 2%. In this example, the transmission of the glass was above 98% which has to be compared to the uncoated reference probe which showed a transmission of 91.5%.

### Example 2

### Multiple Layer Application

The second example relates to the production of a high transmission coating on a glass pane wherein the coating comprises at least two layers of porous silicate with different optical properties. The steps of glass preparation and application of the potassium silicate solution are carried out as described above with respect to Example 1.

Then, for producing the first layer the potassium silicate solution is dried under ambient atmosphere rather than being cured in a controlled process atmosphere. By drying the silicate solution under ambient atmosphere a silicate layer is achieved which has a thickness controlled to be ¼ lambda for the selected EMS (electro magnetic spectrum) wavelength. The density of that layer is higher than the density of the silicate layer produced in Example 1.

The first silicate layer is then washed with a mildly acidic HCl solution to remove potassium carbonates and to prepare the surface for the subsequent second application of a potassium silicate solution. Immediately after the washing step a second potassium silicate solution is sprayed on top of the first silicate layer by means of nitrogen as propelling gas. In this particular Example the same potassium silicate solution as for the first layer is used. But it is also possible to use potassium silicate solutions of different composition, in particular of different concentration, for production of the first layer and for production of the second layer.

The second silicate solution is cured in a controlled process atmosphere with a controlled relative humidity. During this step it is possible but not necessary to inject controlled amounts of HCl vapour into the process atmosphere. Thereby, the cross-linking of the silicate units and the formation of potassium carbonates is manipulated resulting in a more porous coating compared to the first silicate layer.

Finally the glass is dried, washed and dehydrated.

By using the multi layer application coatings can be produced which show a higher maximum transmission compared to one layer coatings and a broader wavelength range with high transmission.

The inventive method is preferably integrated into a glass production line. In the glass production line a glass melt is formed to be flat glass in the form of a continuous ribbon. According to an embodiment of the invention a potassium silicate solution is applied to the surface of the continuous glass ribbon. In a particular preferred embodiment the potassium silicate solution is applied to float glass. The invented process can be integrated into the glass manufacturing process and can be carried out in-line. Creating an anti-reflective and high transmission surface structure can be achieved in-line and in particular before the flat glass has been cut, edged and/or drilled.

The invention is preferably used for coating of float glass which is produced by means of floating on a tin bath. The present invention can also be used in the production of other types of flat glass including rolled glass, patterned glass, drawn glass, and figured glass. For example the glass melt can be formed by rollers to a glass ribbon to which a potassium silicate solution is applied. Irrespective of the type of production method for producing the flat glass the application of potassium silicate solution is preferably carried out onto the glass ribbon in the production line. In the above described production process for achieving the anti-reflective surface structure potassium silicate solution is applied only to one side of the glass ribbon. However, if appropriate potassium silicate solution can also be applied to both sides of the glass ribbon to form on both sides a nanostructured surface.

It is also possible to integrate the inventive process into a glass processing line where one or more of the following steps are performed: tempering, machining, cutting, edging or drilling the glass. It is preferred to perform the glass processing process and the inventive application of potassium silicate solution and the subsequent formation and development of a porous silicate coating in-line in order to reduce the complexity and the costs of the process.

The invention as well as further details of the invention shall be explained with reference to the attached drawing.

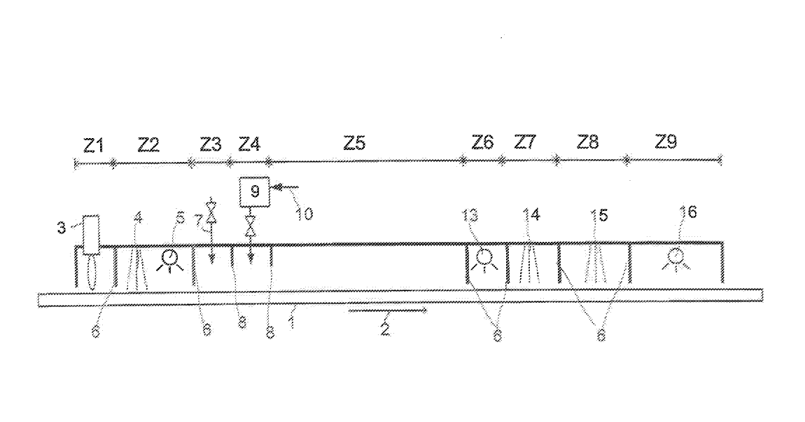

FIG. 1 schematically shows the equipment to carry out the inventive process integrated into a glass processing line.

FIG. 1 shows a coating section in a glass processing line in which glass 1, for example an endless glass ribbon, is coated with a high transmission coating. The glass processing line may comprise one or more additional sections (not shown) for cutting, drilling and/or tempering the glass 1.

The coating section comprises nine zones Z1 to Z9. The glass 1 is transported along a transportation path 2 at a speed of typically 10 meters per minute and thereby passes consecutively zones Z1 to Z9. The different zones Z1 to Z9 are partly separated from each other by baffles 6. As it will be explained below the baffles 6 shall ensure that in the different zones Z1 to Z9 the glass 1 can be subjected to atmospheres of different composition.

In the first zone Z1 the glass 1 is subjected to a flame treatment to prepare the glass surface 1 for the subsequent coating steps. A burner 3 heats up the glass surface 1 to a temperature between 100° C. and 400° C. in order to burn impurities on the surface. It is also possible to use a plasma torch, in particular a torch for generating an atmospheric plasma, to activate the glass surface 1.

Next, the glass 1 is passed to zone Z2 where the glass surface is washed with water and dried. Clean or deionised water 4 is sprayed onto the glass surface. Instead of or in addition to the described water spraying the glass surface may be treated by mild acid solutions or any other suitable liquids. Then the glass is dried by means of an infrared lamp 5. After having passed zones Z1 and Z2 the glass surface has got defined surface conditions.

In zone Z3 wet air 7 of controlled humidity is introduced. The wet air is produced by bubbling air through a water bath in order to get air with a certain humidity. The relative humidity of the air 7 can be influenced by the temperature of the water bath and by addition of dry air to the wet air leaving the water bath.

By the introduction of the wet air 7 a humid atmosphere is produced. Zones Z3, Z4 and Z5 are only separated from each other by small baffles 8 which allow an exchange of the atmosphere through zones Z3, Z4 and Z5. The flow of wet air 7 introduced into zones Z3, Z4, Z5 is set such that the atmosphere in these zones Z3, Z4, Z5 is saturated with water vapour. The relative humidity of the atmosphere is 100%.

In zone Z4 a potassium silicate precursor 9 is applied to the glass surface 1. The precursor 9 consists of an aqueous potassium silicate solution with a molar ratio of SiO₂: K₂O between 4:1 and 5:1. The concentration of potassium silicate in the potassium silicate solution is between 1% by volume and 3% by volume. A dry nitrogen flow 10 is used as a propellant to push the aqueous potassium silicate solution from the potassium silicate vessel 9 into zone Z4.

The aqueous potassium silicate solution 9 is sprayed onto the glass 1 forming a thin liquid layer of preferably 5 to 10 micrometer thickness on the glass surface 1. The humid process atmosphere in zones Z3, Z4 and Z5 prevents water from evaporating from the aqueous potassium silicate solution 9. That means the liquid potassium silicate layer is maintained during the passage of the glass 1 through zones Z3, Z4, Z5.

Next, in zone Z5 the CO₂ present in the air of the process atmosphere is allowed to react with the liquid layer of aqueous potassium silicate solution on the glass 1. Thereby, the pH of the potassium silicate solution will decrease and the silicate units in the solution will start to nucleate by cross-linking and oligomerise to form silicate agglomerates, silicate chains and nano-colloids.

As described above, the development and cross-linking of the silicate chains occurs in the liquid state since the humid atmosphere in zone Z5 prevents drying of the potassium silicate solution. The nucleation sites at which the cross-linking starts are wide spread in the potassium silicate solution layer on the glass giving a final coating of high porosity.

After the silicate units have cross-linked and a porous silicate structure has been formed in the aqueous solution the glass enters zone Z6. In zone Z6 the water in the aqueous solution is rapidly evaporated and the produced porous silicate coating is dried. The drying is assisted by infrared radiation from an infrared source 13.

Residual potassium-containing molecules, for example potassium carbonates, are washed out in zone Z7 with a 10% hydrochlorid acid 14 in order to extend the lifetime of the treated glass 1 and to improve the optical properties. The hydrochlorid acid 14 is sprayed onto the surface of the glass 1.

Finally, the glass 1 is washed in zone Z8 with water 15 and dried and cured in zone Z9 by heating up to a temperature between 200° C. and 250° C. The heating may be achieved by infrared radiation 16 or by electrical heating.

The length of the different zones Z1 to Z9 are chosen in such a way that at a given transportation speed the glass remains for a pre-determined time in each zone Z1 to Z9. As schematically indicated in FIG. 1, the lengths of the zones Z1 to Z9 differ from each other.

1. A method for producing a high transmission coating on a glass surface, comprising applying an aqueous potassium silicate solution to the glass surface, exposing the potassium silicate solution while in liquid phase to a process atmosphere, and controlling a relative humidity of the process atmosphere during said exposing.

2. The method according to claim 1, wherein the process atmosphere comprises air selected from the group consisting of air with controlled humidity, and air with a predetermined humidity.

3. The method according to claim 1, wherein the controlling comprises passing a gas selected from the group consisting of air, an inert gas, and nitrogen through water for loading said gas with water vapour to which the potassium silicate solution is exposed.

4. The method according to claim 1, wherein the relative humidity of the process atmosphere is higher than the relative humidity of surrounding ambient atmosphere.

5. The method according to claim 1, wherein the relative humidity of the process atmosphere is higher than at least one of 60%, 70%, 75%, 80% and 90%.

6. The method according to claim 1, wherein said glass surface is at a temperature between 15° C. and 80° C. during the exposing to said process atmosphere.

7. The method according to claim 1, wherein a concentration of potassium silicate in the potassium silicate solution is selected from between 0.5% by volume and 10% by volume, between 0.5% by volume and 3% by volume, and between 0.5% by volume and 1.5% by volume.

8. The method according to claim 1, wherein the potassium silicate solution comprises a molar ratio of SiO₂:K₂O between 3:1 and 6:1.

9. The method according to claim 1, wherein said high transmission coating is produced on flat glass.

10. The method according to claim 1, wherein the controlling comprises controlling a concentration of water vapour in the process atmosphere or the relative humidity of the process atmosphere to keep the potassium silicate solution in the liquid phase for a predetermined period of time.

11. The method according to claim 10, further comprising controlling a partial pressure of the water vapour in the process atmosphere to keep the potassium silicate solution in the liquid phase for a period of time selected from the group consisting of at least 2 minutes, at least 5 minutes, and for at least 7 minutes.

12. The method according to claim 1, further comprising drying the glass surface after said exposing to the process atmosphere, said drying selected from a dry atmosphere, and infrared heating.

13. The method according to claim 1, further comprising pre-treating the glass surface prior to applying the aqueous potassium silicate solution to the glass surface, said pre-treating selected from the group consisting of washing the glass surface with water, rinsing the glass surface with a mild acid solution, applying a flame treatment to the glass surface, and applying a plasma treatment to the glass surface.

14. The method according to claim 1, further comprising adding an acid forming gas to the process atmosphere.
